(19) United States
(12) Patent Application Publication
(10) Pub. No.: US 2011/0297621 A1
(43) Pub. Date: Dec. 8, 2011

(54) Crouse air bubble oil barrier

(76) Inventor: Timothy Christian Crouse, Murray, KY (US)

(21) Appl. No.: 13/134,491

(22) Filed: Jun. 7, 2011

Related U.S. Application Data
(60) Provisional application No. 61/397,214, filed on Jun. 7, 2010.

(51) Int. Cl. C02F 1/24; C02F 101/32

(52) U.S. Cl. 210/703

(57) ABSTRACT

A Air Bubble Barrier blockade is a new invention that can be used in a oil spill response as a ‘blockade’ or ‘barrier’ to prevent oil from entering a area to be protected. The Air Bubble Barrier works by releasing a wall of air bubbles 133 from below the water surface, usually from a Bubble Pipe system 137 and anchored on the floor of a body of water floor, so that the rising air bubbles 133 form a up-current which reverses or halts the surface current thereby preventing or slowing surface pollutants such as oil from entering a area, while also making skimming or suctioning easier and putting oxygen back into the water.

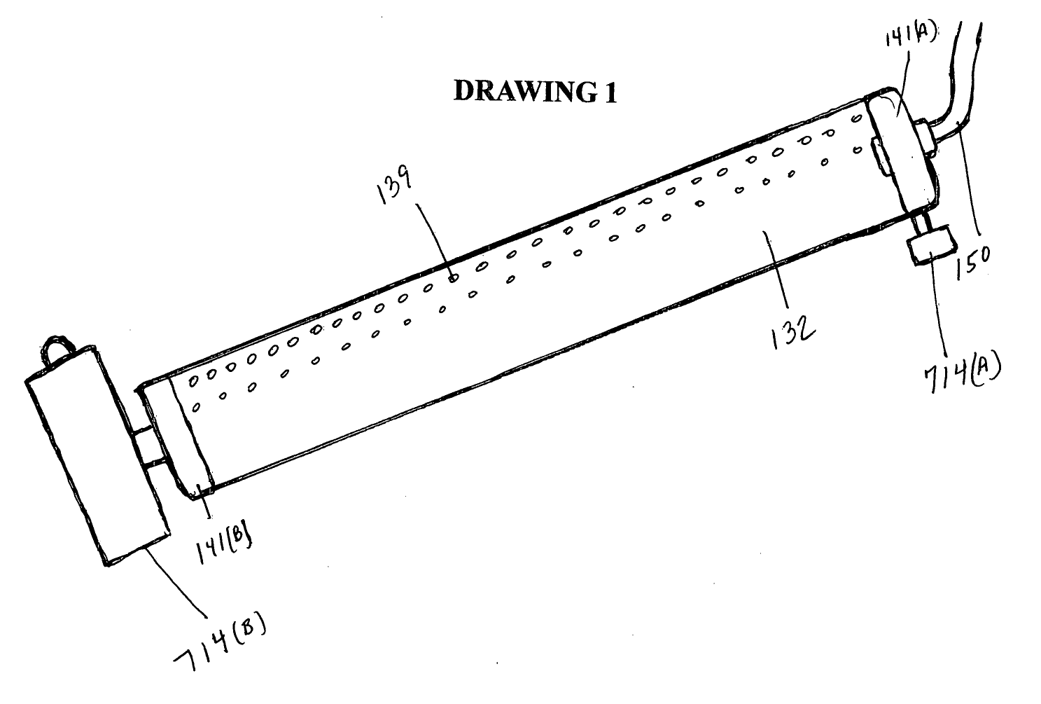

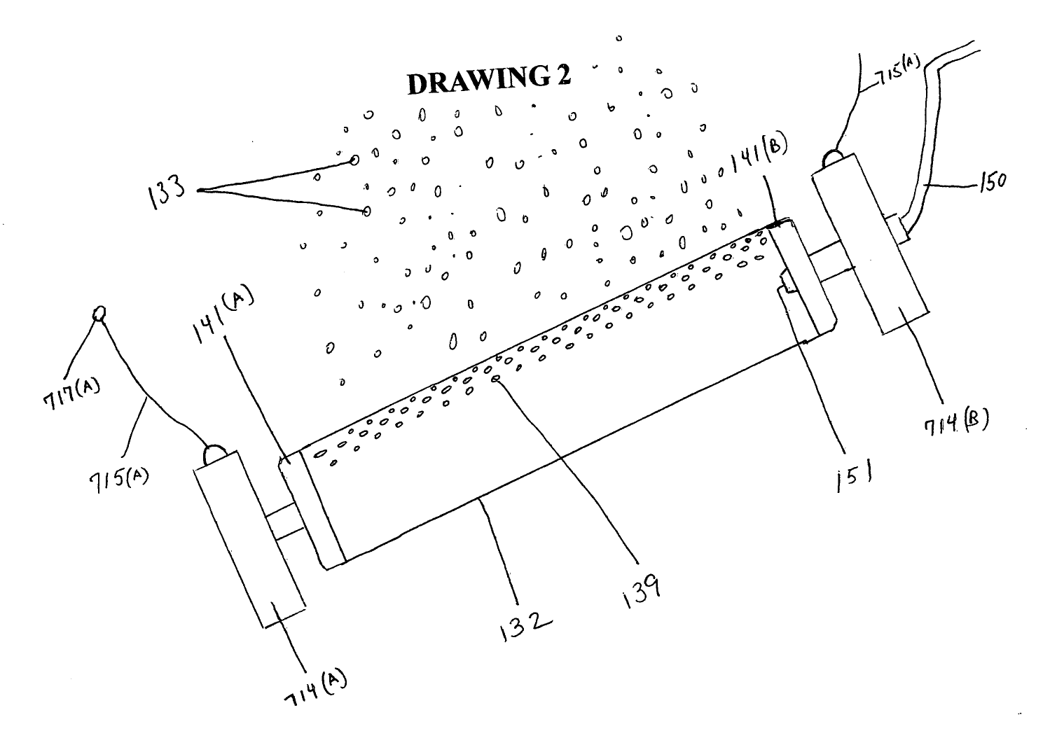

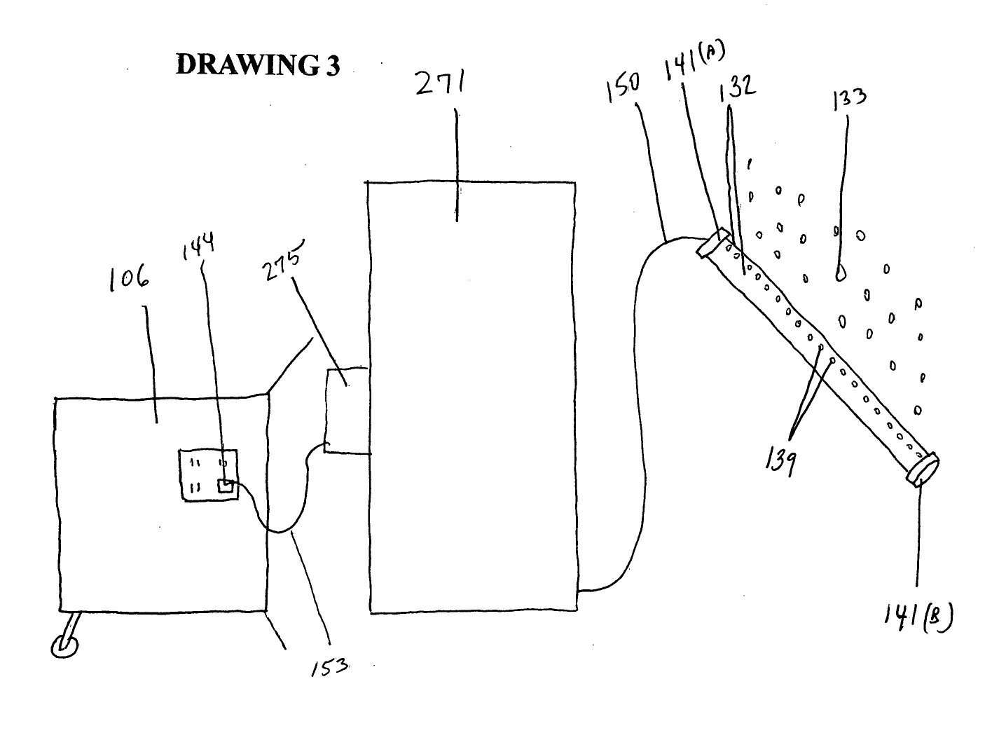

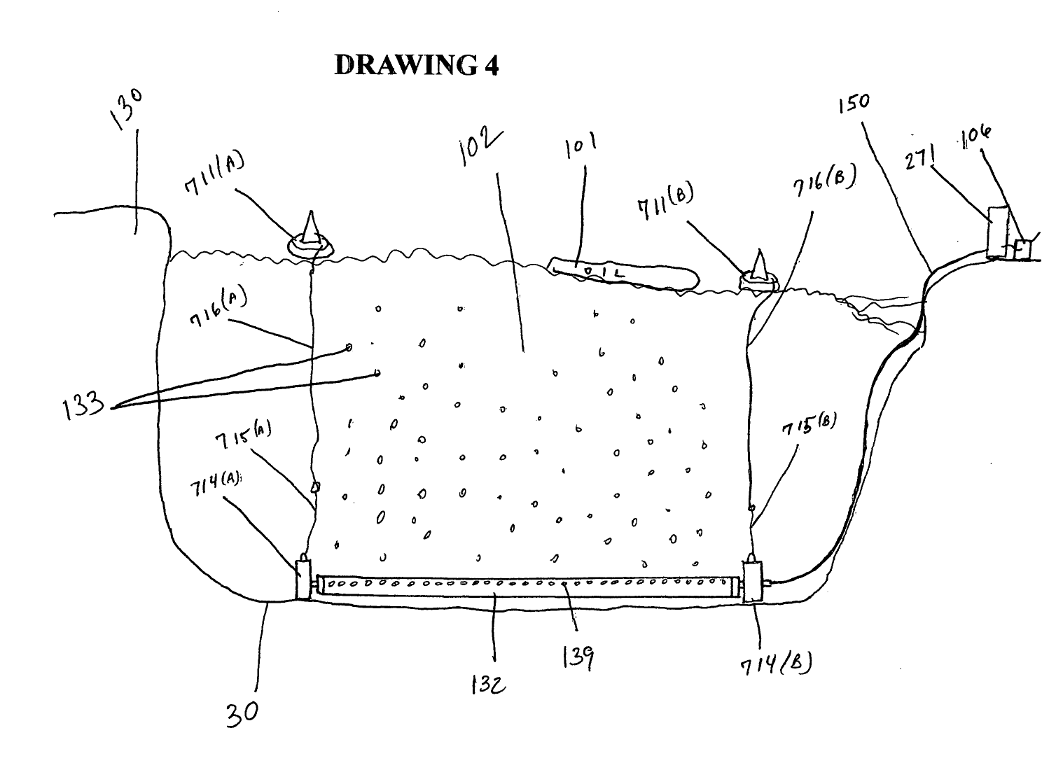

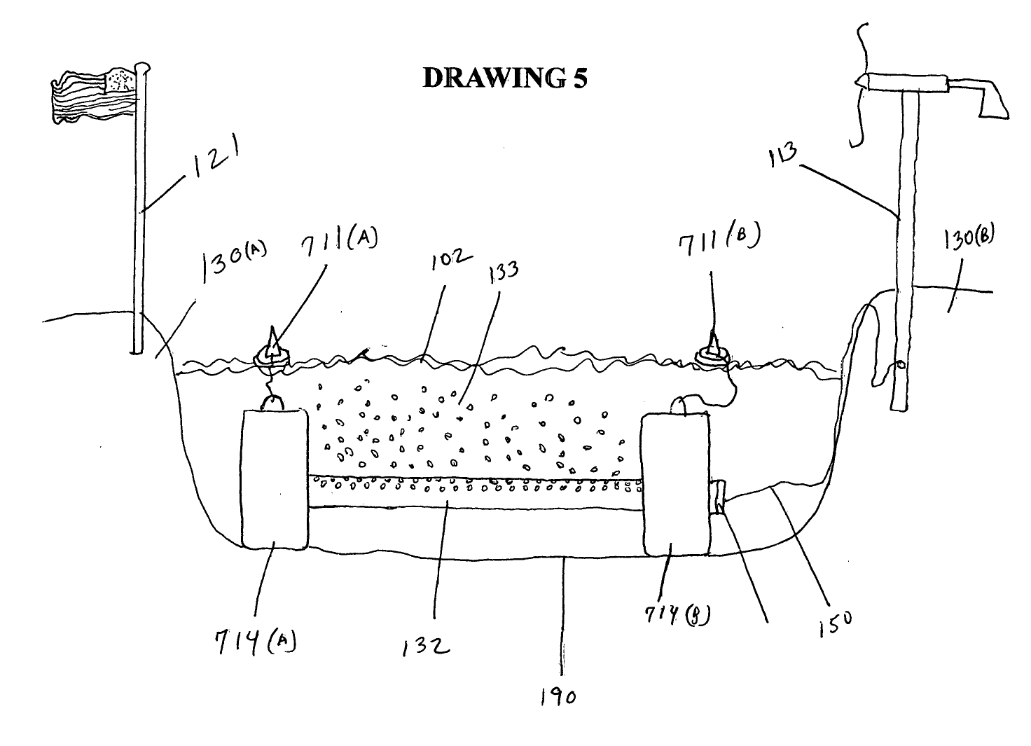

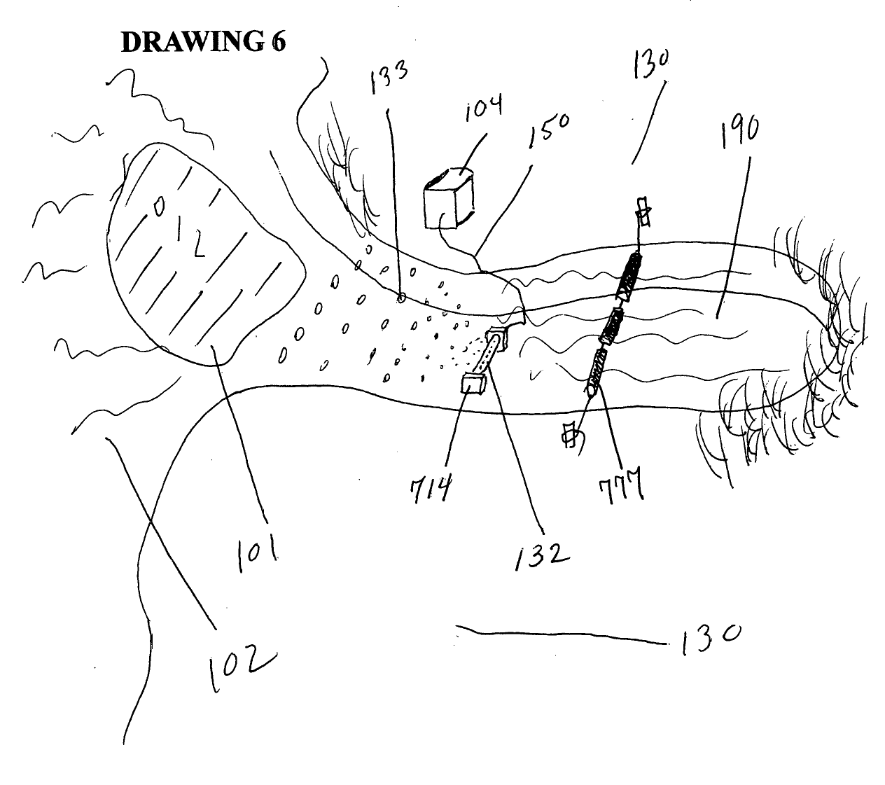

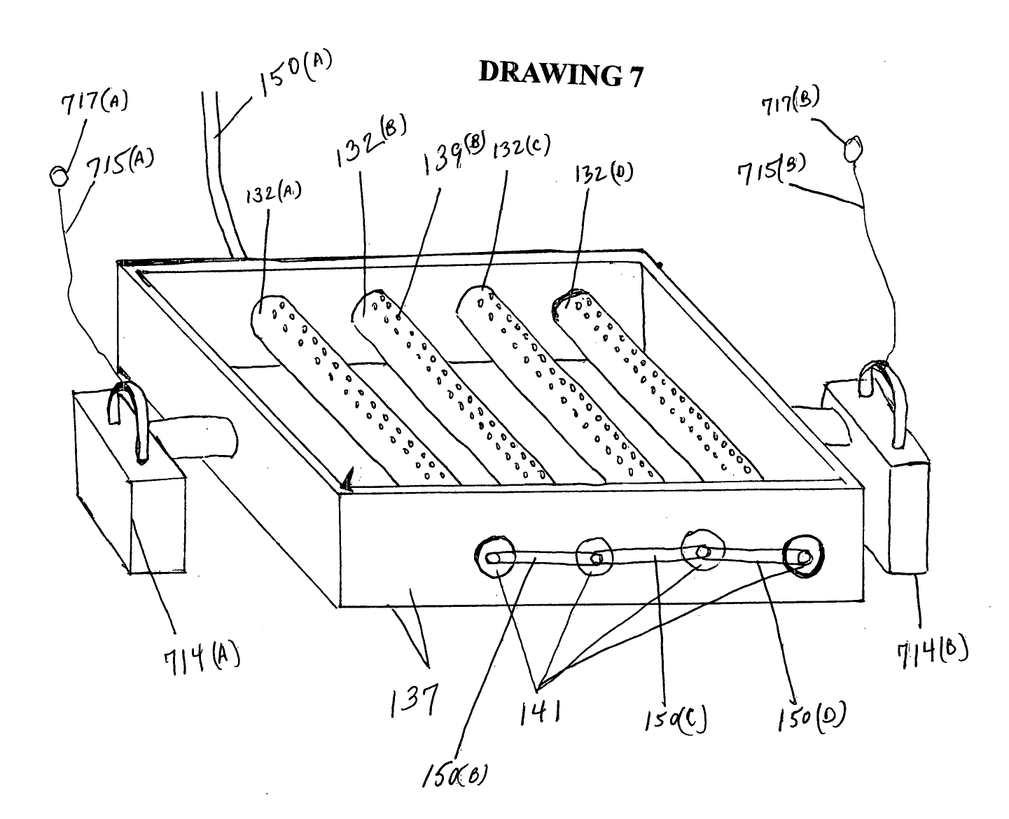

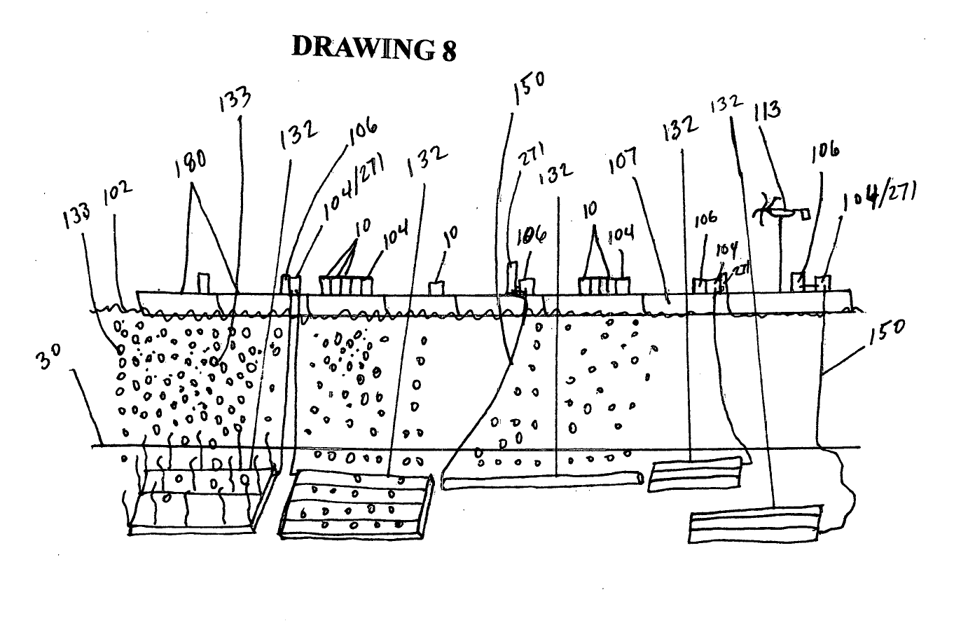

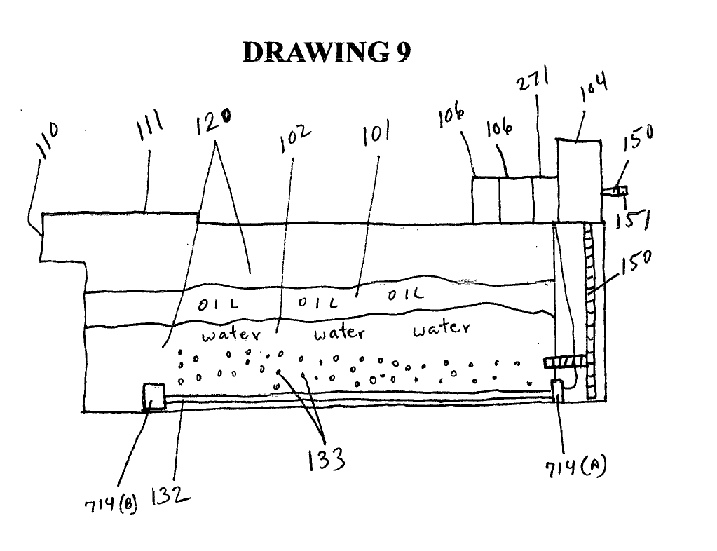

### RELATION TO PRIOR APPLICATION

This non-provisional patent application is based on and claims the benefit of the prior provisional application, U.S. Ser. No. 61/397,214 filed on date: Jun. 7, 2010.

### BACKGROUND OF THE INVENTION

I. Field of The Invention

This non-provisional utility patent application is for a new invention, called a Air Bubble Barrier, which has applications in the oil spill response and or clean-up industry. This is a environmentally friendly invention that can be used to help prevent or blockade oil from entering Bays, fisheries, the shoreline, etc. This invention can simultaneously be used to put oxygen back in the water where oil spills are occurring. This invention can be used alongside or with other inventions or techniques, etc. in a oil spill response to improve overall clean-up efficiency and or effectiveness.

### SUMMARY OF INVENTION

This is a non-provisional utility patent application for a Air Bubble Barrier, which is a new invention that can be used in the oil spill clean-up and or response industry. The Air Bubble Barrier can be used by itself or alongside other response measures, equipment, and or techniques to prevent oil from entering a certain area, usually a Bay or shallow water area is a body of water such as: oceans, rivers, lakes, marshes, swamps, ditches, canals, etc. The Air Bubble Barrier is a barrier of air bubbles that can be used to stop or slow the movement of oil floating on the surface of the water; and the air bubbles can be used to keep the oil at the top of the water thus preventing mixing and or saturation; and the bubbles can also put oxygen into the water, etc.

For this application, the term ‘oil’ will be used to describe oil and or any contaminant having a specific gravity less than 1.0.

Recent spills and mishaps have led to search for new and better methods to clean up oil spills. Other tools and equipment currently used, such as dispersant, can actually do more much harm to the environment than they are meant to solve. There are obvious deficiencies in the efforts used to date. Therefore, the need exists for adding new options and better oil spill clean-up equipment to the overall list of equipment and or techniques.

### BACKGROUND AND PRIOR ART

One of the traditional or current methods and or approaches for the oil clean up process has been to place large ‘containment booms’ out in the water. The ‘containment booms’ are objects which float on top of the water, they are set in formations to direct the flow of oil to collection areas, and they act as a barrier between the non-contaminated water and the actual oily or contaminated water. The booms are flimsy at best, and they are mostly a passive system that require a lot of man hours to operate. Efforts can be made in using the absorbent booms to extract small amounts of the oil from the water, but once saturated they have to be taken up, cleaned, and replaced; and in big spills it is too much to handle for even a army of responders. The booms do relatively good for visibly showing the spill location over larger areas when looking from the water level or from the air when in place. However, in large ocean spills, the booms have been overrun and rendered basically ineffective due to the waves and normally present ocean conditions which often move the booms way off course so that they break formation, or become beached; thus becoming ineffective. take in.

In years past, the containment booms have often been the only response measures for creating a barrier or blockade. New equipment is needed to both back up the containment booms and for use in the shallow waters and or environmentally sensitive areas, such as: swamps, marshes, near shoreline and shoreline areas, reefs, etc. to increase the overall response and or clean-up effectiveness; and do so without harming the environment. The Air Bubble Barrier provides a new and much needed option.

### BRIEF DESCRIPTIONS OF THE DRAWINGS

Drawing 1 is a exploded or up close, out of the water, right side view of a Air Bubble Pipe.

Drawing 2 is a exploded or up close in the water view of the right side of a Air Bubble Pipe shown working or with bubble coming out.

Drawing 3 is a compact, out of the water, view of a entire Air Bubble Barrier ‘system’ showing one option or design for all the components needed to make it work:

Drawing 4 is a ‘see through the water,’ side view of the water line to the sea floor, showing the application of a Air Bubble Barrier system working.

Drawing 5 is a ‘see through the water,’ side view of the water line to the sea floor, showing the application of a Air Bubble Barrier system working.

Drawing 6 is a ‘see through the water’ to the sea or Bay floor overhead view of a Air Bubble Barrier as if working in a applicable situation blocking a Bay.

Drawing 7 is a up close view of a alternative design option of a Air Bubble Piping system using multiple pipes.

Drawing 8 shows a ‘see through the water’ side view to the sea floor of a floating Barge Barrier system with multiple designs for the Air Bubble Barrier Pipe systems underneath releasing bubble for aiding in the blockade and working with the barge barrier:

Drawing 9 shows a ‘see through’ Barge Skimmer, with a Air Bubble Barrier inside and helping with the oil from water separation process.

### DETAILED DESCRIPTION OF THE PREFERRED EMBODIMENT

This non-provisional utility patent application for a new oil spill response technology called a ‘Air Bubble Barrier’ 160. The Air Bubble Barrier is a blockade technique to be used in situations similar to that where traditional booms are applied. The Air Bubble Barrier is environmentally friendly oil response measure used primarily for blocking oil from entering a area of water such as the entrance to a Bay. Though the Air Bubble Barriers can be used by themselves, they should often be used alongside Barge Barriers 180 and or traditional booms 777 so to back-up the protection layers, creating a more redundant barrier system.

The Air Bubble Barrier system works by releasing a wall of Air Bubbles 133, from a (normally) one or more Air Bubble Pipes 132 or from any design of a ‘air bubble units’ 137, from underneath the water line and or most often anchored on the floor of the body of water, so that the air bubbles 133 rising from below the surface to the surface creates a up-current of water. The up-current forms a wall to any incoming ‘lighter than water’ fluid such as oil floating on the water surface. This up-current works to prevent the oil slick from entering the area the Bubble Barrier is protecting. The protection level is only so strong, and it can be overwhelmed by harsh wind and wave conditions. However, when used alongside other oil spill response devices, measures, or techniques, even if the oil gets above the air bubble wall, the air bubbles still act to assist the suctioning or skimming efforts by keeping the oil at the top of the water instead of allowing it to saturate below the water surface.

Adding air bubbles 133 to the water in areas where a oil slick 101 is a issue can also help to add more oxygen to the water to combat oxygen depletion caused by the oil. This can literally save the surrounding environment from complete annihilation.

The Air Bubble Barrier 160 is a relatively simple system. The Air Bubble Barrier 160 will be described by using simple drawings along with simple descriptions associated with the drawings. The concept is very simple, however, there can be many different designs. This utility patent covers all designs possible, but all the possible designs will not be shown in the drawings (or described). In no way do the drawings and or descriptions in this application limit the Air Bubble Barrier to being used in just the discussed or shown locations; or for the applications discussed or shown in the drawings. The drawings are not to any scale, therefore the air bubble bathers can be any size. There is no preference as to what type of compressor or pump system creates the air for the barriers, and in no way does this application limit the Bubble Bather system to having to use just the listed compressors or windmills, etc. Many different materials can be used to make up all parts of a Air Bubble Barrier system. In no way does this application limit the Air Bubble Bather system to a certain material make-up.

Drawing 1 shows a up close semi exploded view of one part of a Air Bubble Barrier System 160 called a Air Bubble Pipe 132. To make a Air Bubble Pipe 132, simple tiny holes 139 are drilled into and through one side of the pipes, (but alternative designs can use other materials such as rubber or plastic tubes, hoses, etc.) and lengthwise, from one side of the pipe to the other: On a single pipe system, such as in Drawing 1, both ends of the pipe are capped 141 (A) and 141 (B) so that the caps are air tight. A hose 150 is connected or inserted through one side of the pipe through the pipe cap. In Drawing 1 the hose 150 is connected at Cap 141 (A). The working from there is simple. Air is pumped through the hose 150 and into the pipe 132 where the air escapes through the holes 139 releasing air into the water forming air bubbles. The Air Bubble Pipe 132 is usually positioned on the floor of the body of water, and it is normally in front of or between other surface bathers, such as: Booms 777, Barge Barriers 180, etc. The Air Bubble Pipes 132 are usually set on the floor of a shallow water area, from one side to the other, covering the entrance to a Bay, Marsh, reef, etc. areas. The Air Bubble Pipes can be held in place using anchors at one or both ends of the pipes 132. Anchors 714 (A) and (B) are shown at each end of the pipe in Drawing 1. Anchors 714 (A) and (B) have loops added where strings 715 (A) and (B) are tied so to lower the Barrier System in place from a boat or vessel, etc.

Drawing 2 shows a similar version to drawing 1 except in drawing 2, it shows the released air as if it were released under water. The air released has formed Bubbles. A well placed wall of Bubbles 133 guarding the entrance to a Bay, swamp, marsh, reef, etc. is all that is needed to form a bubble bather 133. Usually, there would be several layers of pipes under water, as well as a multitude of Bubbles 133 forming a long several feet thick Air Bubble Barrier or blockade:

Drawing 3 shows a example complete Air Bubble Barrier system 160. The Pipe Barrier 132 has already been discussed in previous drawings. The hose attached to the pipes 150 that connects to the cap or Air Bubble Pipes also connects at the other end, in this drawing, to a Air Compressor 271. The Air Compressor 271 is connected via Electric Cord 153 at Plug Location 144 where it is powered by Electric Generator 106. Basically, the Generator 106 provides AC or DC, etc. power to the Air Compressor motor 275 causing the Air Compressor 271 to start pumping and compressing air. The air is released through the hose 150 where it goes through cap 141 (A) and into the Bubble Pipe 132, where it fills the pipe due to the air tight cap 141 (B) not allowing the air to pass through the cap. The air inside the cap builds pressure, whereby the air escapes through holes 139. As the air escapes under water, the air forms Bubbles 133 which rise to the top of the water 102. A bunch of bubbles coming out of one or more pipes can form a barrier in the water from the floor of the water to the surface and at the surface.

Drawing 4 shows a see-through the water line, to the bottom or floor of the body of water, side view, whereby a long Bubble Pipe 132 is positioned via anchors 714 (A) and (B) on the floor from one side to the other of the Bay entrance. The Buoys 711 (A) and 711 (B) have drop strings 716 (A) and (B) attached to the anchor strings 715 (A) and (B) so that the ends of the pipe locations are marked at the surface of the water. The use of the Buoys can be for ease of pick-up and or collection, and they can be to provide a visible surface mark where people can see from a distance showing the entrance of a bay or where a bubble barrier has been set, etc. In drawing 4 the sides of the Bay are marked at 130, and at one side the power system is setting on the bank. The power systems would normally likely be sitting on a dock, anchored vessel, a barge wall or barrier, etc. In this case, there is a Generator 106 connected to a Air Compressor 271 where a hose 150 runs from the compressor to the end of the Bubble Pipe 132 and enters at position 714 (B) (where in this case the anchor 714 (B) contains a nozzle connector where the hose can attach): The air bubble barrier 133 is formed by the wall of bubbles released making their way to the surface of the water. Because of the density changes in air at water depths, air expands as it rises to the surface. This means that as the air bubbles 133 rise through the water, and they get closer to the top, the air bubble expands making it rise to the surface with greater force. This makes air bubbles great for not only blocking the entrance of oil water on the water surface, it also makes bubbles have the ability to block many other contaminants below the water surface forcing them to the top of the water as well. Because the bubble force the incoming oil and contaminants to the top so well, it makes suctioning the oil and other mess easier from off the sides of a barge barrier.

Drawing 5 shows the same view as drawing 4, except the difference in this case is that the air is being supplied by a Windmill 113 aeration device. Windmills are often used in ponds to supply oxygen, however, in this case it is used to supply air to a Bubble Pipe 132. Also in this drawing, the Anchors 714 and Bubble Pipe system 132 are

Drawing 6 shows a see through the water to the bottom or Bay floor, overhead view, of a Bay 190 entrance where a oil slick 101 is incoming from a main body of water 102 (on the left), and the oil slick 101 is attempting to enter a Bay 190 blockaded by a Air Bubble Barrier system created by a all-in-one Vacuum/Pump Generator 104 system pumping air through a hose 150 to a anchored 714 Bubble Pipe 132; and it is being backed up with a Boom 777 system stretching from one side of the Bay to the other. The drawing 6 attempts to show a wall of bubbles 133 from the Bay Floor, coming out of the Bubble Pipe 132 and rising to the water surface. The drawing 6 is also meant to show a applicable use and possible location for use.

Drawing 7 shows a different or alternative design for a Pipe Barrier 132 system whereby multiple Bubble Pipes 132 (A), (B), (C), and (D) are all in a frame 137 which is anchored via anchors 714 (A) and (B). The hose 150 pumps air into Bubble Pipe 132 (A), where the hoses 150 (B), (C), and (D) attach each pipe at location 141 so that the air flowing into Pipe 132 (A) fills all the pipes. Each pipe has tiny holes drilled lengthwise along the tip, just as a single Bubble Pipe would. In this case, from one hose intake area, and from one Bubble Barrier system, a larger Bubble Barrier would form, thus creating a larger barrier. Of course the more pipes added, the more need for air volume, unless the pipes are made in a smaller diameter. This drawing shows one of several options for design.

Drawing 8 shows a see-through the water line side view, from the floor of the body of water to the surface of a air bubble barrier 160 providing a blockade alongside a Barge Barrier. This drawing shows a very applicable use for the Bubble Barrier system. The Bubble Barrier is located underneath one side of a Barge Barrier, and the Bubbles would work to push all the incoming oil to the surface so that skimmers and or the suction equipment on the barge would be able to better or more easily suction the oil from the water. More designs for the Bubble Frames and or other parts of the overall system are also visual.

Drawing 9 shows another location for where the Bubble barrier system can be used in oil spill response. This drawing shows a see-through view of a Barge Skimmer 107 where a Bubble Pipe 132 has been placed at the bottom of a Barge Skimmer collection tank 120. The collection tank 120 is filled with oil 101 and water 102 just suctioned or skimmed from the water during a skimming operation. Inside the tank 120, the air bubbles 133 released at the bottom of the tank acts to push the oil 101 and debris to the surface while the clean water 102 settles at the bottom. This is a water and oil separation technique that can be applied to the Barge Skimmers to make the skimming more efficient and effective. The drain to the pipe or hose 150 that is extended to the bottom of the barge skimmer collection tank 120, will be opened at location 151. When opened, a vortex is created letting out a portion of the clean water, and the water will be cleaner due to the bubbles.

I. A new method for responding to oil spills by creating a barrier or blockade in a body of water so to protect or keep oil from moving into a area, by,
(a.) setting a Bubble Pipe 132 or Bubble Barrier Structure 137 below the water surface, often anchored 714 at the floor or bottom of the body of water and,
(b.) connected to a Air Compressor 271 or other air producing and or pumping equipment, via a hose 150,
(c.) where the air pumped into the Bubble Pipe 132 filling the pipe with air, but the Bubble Piping having tiny holes drilled into and through the pipe lengthwise from one end to the other along the top of one or more sides of the pipe so that the air is released through tiny holes 139 in the Bubble Pipe(s),
(d.) which when the air is released under water, the air forms bubbles 133 in the water rising from the Bubble Pipe 132 or structure 137 to the water surface so that the rising air creates a barrier or wall of Air Bubbles 133,
(e.) where the rising air bubbles 133 creates a up-current in the water thus forming a reversed surface current,
(f.) where the reversed surface current then slows or stops incoming oil 101 or debris which may be floating on, at, or near the water,
(g.) which when used alongside or with other barriers provides a extra measure of protection from oil moving into the surrounding environment,
(h.) the air bubbles 133 also acts to keep oil and debris at the top of the water for easier suction, skimming, and or for use in water cleaning applications after the oil is skimmed and or contained,
(i.) the air bubbles 133 act to put much needed oxygen back into the water in a area polluted by a oil spill.

II. A method of pushing oil and debris to the surface of the water to make skimming and or suctioning easier while providing oxygen to the water during a oil spill,
(a.) by releasing a wall of air bubbles underneath the water,
(b.) thereby pushing everything in the water that the bubbles 133 can push upward to the surface,
(c.) while also releasing oxygen into the water combating the depleting effects of the oil.

III. A method of cleaning water inside the skimmers 107 and or skimmer collection tanks 120, by,
(a.) using the Air Bubble Piping 132 or structures 137 to released air from the bottom of the tank to the surface,
(b.) forming a wall of air bubbles 133 inside the collection tank 120 so to push the oil and debris to the to surface of the water within the collection tanks 120,
(c.) so that the clean water 102 settles to the bottom of the collection tank 120 while the oil gets pushed to the top of the water 101,
(d.) thereby allowing the cleaner water 102 to be drained or pumped out at the bottom of the tank, while the purer oil 101 can be pumped or suctioned out at the top,
(e.) a method of putting or supplying oxygen to the collection tanks to keep sea life alive in case any fish, turtles, or other sea life may have been suctioned during skimming or vacuum operations, so that when released they are healthier and have a better chance for surviving the oil skimming ‘situation.’
